(19) United States
(12) Patent Application Publication
(10) Pub. No.: US 2015/0002101 A1
(43) Pub. Date: Jan. 1, 2015

(54) SULFIDE SOLID BATTERY SYSTEM AND METHOD FOR CONTROLLING SULFIDE SOLID BATTERY

(71) Applicants: Hajime Hasegawa, Susono-shi (JP); Keisuke Omori, Kariya-shi (JP); Yasushi Tsuchida, Susono-shi (JP)

(72) Inventors: Hajime Hasegawa, Susono-shi (JP); Keisuke Omori, Kariya-shi (JP); Yasushi Tsuchida, Susono-shi (JP)

(73) Assignee: TOYOTA JIDOSHA KABUSHIKI KAISHA, Toyota-shi, Aichi (JP)

(21) Appl. No.: 14/378,026

(22) PCT Filed: Mar. 6, 2012
(86) PCT No.: PCT/JP2012/055658

§ 371 Date: Aug. 11, 2014

(51) Int. Cl. H02J 7/00; H01M 10/052; H01M 4/525; H01M 4/505; H01M 10/46

(52) U.S. Cl. CPC H02J 7/007; H01M 4/505; H01M 10/46; H01M 4/525; H01M 10/052; H01M 2220/20
USPC 320/134; 320/162; 320/136

(57) ABSTRACT

The present invention provides a sulfide solid battery system including: a solid battery including a cathode layer, an anode layer and a solid electrolyte layer disposed between the cathode layer and the anode layer; and a controller capable of controlling a charge-stopping voltage of the solid battery, wherein: LiNiₓCo_{y}Mn_{z}O₂ (x+y+z=1 and 0.32<x, y, z<0.34) is employed for the cathode layer and a sulfide solid electrolyte is employed at least for the solid electrolyte layer; and the charge-stopping voltage of the solid battery is controlled by the controller in charging the solid battery so that the charging is stopped at 4.3 V or less with reference to a potential at which graphite stores/releases lithium ions, in order to improve a cycle characteristics of the sulfide solid battery.

### BACKGROUND OF THE INVENTION

1. Field of the Invention

The present invention relates to a sulfide solid battery system and a method for controlling a sulfide solid battery.

2. Description of the Related Art

A lithium-ion secondary battery has a higher energy density than other conventional secondary batteries and can be operated at a high voltage. Therefore, it is used for information devices such as a cellular phone as a secondary battery which can be easily reduced in size and weight. In recent years, there has also been an increasing demand of the lithium-ion secondary battery to be used as a power source for large-scale apparatuses such as electric vehicles and hybrid vehicles.

The lithium-ion secondary battery includes a cathode layer, an anode layer and an electrolyte layer disposed between them. As an electrolyte to be used for the electrolyte layer, a non-aqueous substance in liquid form or solid form and the like have been known for example. When a liquid electrolyte is used (hereinafter referred to as an “electrolytic solution”), it easily permeates into the cathode layer and the anode layer. Therefore, it is possible to easily form an interface between the electrolyte and an active material contained in the cathode layer and the anode layer, and to easily improve the performance of the battery. However, since widely-used electrolytic solutions are flammable, it is necessary to mount a system to ensure safety. By contrast, electrolytes in solid form (hereinafter referred to as “solid electrolytes”) are non-flammable, thus enabling simplification of the above system. As such, the development of a lithium-ion secondary battery provided with a layer containing the non-flammable solid electrolyte (hereinafter the battery being referred to as a “solid battery”, and the three layers of cathode layer, solid electrolyte layer and anode layer being laminated to each other being referred to as an “electrode body”) has been proceeded.

As a technique related to the lithium-ion secondary battery described above, for example Patent Document 1 discloses a charging and discharging apparatus for a secondary battery including: one or more secondary battery(ies) including a lithium ion conductive solid electrolyte; and a controller for controlling charging and/or discharging of the battery(ies), wherein the controller carries out charging the secondary battery (ies) in which an abnormality is detected in the voltage and/or current in charging, with a pulse wave and/or a low charging voltage. Patent Document 1 also discloses a method for controlling charging and discharging of a secondary battery, the method including charging a second battery, detecting an abnormality occurred in the secondary battery, and charging the secondary battery in which an abnormality is detected in the voltage and/or current, with a pulse wave and/or a low charging voltage.

### CITATION LIST

### Patent Literatures

Patent Document 1: Japanese Patent Application Laid-Open (JP-A) No. 2010-40198

### SUMMARY OF THE INVENTION

### Problems to be Solved by the Invention

With the technique disclosed in Patent Document 1, the deterioration of the secondary battery(ies) cannot be figured out until an abnormality is detected. Therefore, a cycle characteristics of charging and discharging of the secondary battery (hereinafter referred to as “cycle characteristics”) is possibly degraded.

Accordingly, an object of the present invention is to provide a sulfide solid battery system and a method for controlling a sulfide solid battery which are capable of improving the cycle characteristics.

### Means for Solving the Problems

As a result of an intensive study, the inventors of the present invention found out that a sulfide solid battery in which LiNiₓCo_{y}Mn_{z}O₂ (x+y+z=1 and 0.32<x, y, z<0.34. The same is applied hereinafter) is employed for a cathode active material has different durability (cycle characteristics) depending on voltages to be applied. In specific, the inventors found out that it is possible to improve the cycle characteristics by setting the maximum voltage in charging of the sulfide solid battery in which LiNiₓCo_{y}Mn_{z}O₂ is employed for the cathode active material as 4.3 V or less with reference to a potential at which graphite stores/releases lithium ions (in the following explanation related to the maximum voltage in charging, the expression “with reference to a potential at which graphite stores/releases lithium ions” is sometimes omitted). Further, as a result of the intensive study, the inventors also found out that the cycle characteristics can be improved by setting the minimum voltage in discharging the sulfide solid battery in which LiNiₓCo_{y}Mn_{z}O₂ is employed for the cathode active material as 3.4 V or more with reference to the potential at which graphite stores/releases lithium ions (in the following explanation related to the minimum voltage in discharging, the expression “with reference to the potential at which graphite stores/releases lithium ions” is sometimes omitted). Furthermore, as a result of the intensive study, the inventors also found out that it is possible to obtain a good cycle characteristics by setting the minimum voltage in discharging of the sulfide solid battery in which LiNiₓCo_{y}Mn_{z}O₂ is employed for the cathode active material as 3.4 V or more with reference to the potential at which graphite stores/releases lithium ions even though the maximum voltage in charging is set as 4.4 V with reference to the potential at which graphite stores/releases lithium ions. The present invention has been made based on the above findings.

In order to solve the above problems, the present invention takes the following means. That is, a first aspect of the present invention is a sulfide solid battery system comprising: a solid battery including a cathode layer, an anode layer and a solid electrolyte layer disposed between the cathode layer and the anode layer; and a controller capable of controlling a charge-stopping voltage of the solid battery, wherein LiNiₓCo_{y}Mn_{z}O₂ is employed for the cathode layer and a sulfide solid electrolyte is employed at least for the solid electrolyte layer, and the charge-stopping voltage of the solid battery is controlled by the controller in charging the solid battery so that the charging is stopped at 4.3 V or with reference to a potential at which graphite stores/releases lithium ions.

In the sulfide solid battery in which LiNiₓCo_{y}Mn_{z}O₂ is employed for the cathode active material, by setting the charge-stopping voltage as 4.3 V or less, it is possible to increase a capacity maintenance rate after 1000 cycles of repeated charging and discharging. Therefore, according to the first aspect of the present invention, it is possible to provide a sulfide solid battery system capable of improving the cycle characteristics.

A second aspect of the present invention is a sulfide solid battery system comprising: a solid battery including a cathode layer, an anode layer and a solid electrolyte layer disposed between the cathode layer and the anode layer; and a controller capable of controlling a discharge-stopping voltage of the solid battery, wherein LiNiₓCo_{y}Mn_{z}O₂ is employed for the cathode layer and a sulfide electrolyte is employed at least for the solid electrolyte layer, and the discharge-stopping voltage of the solid battery is controlled by the controller in discharging the solid battery so that the discharging is stopped at 3.4 V or more with reference to a potential at which graphite stores/releases lithium ions.

In the sulfide solid battery in which LiNiₓCo_{y}Mn_{z}O₂ is employed for the cathode active material, by setting the discharge-stopping voltage as 3.4 V or more, it is possible to increase a capacity maintenance rate after 1000 cycles of repeated charging and discharging. Therefore, according to the second aspect of the present invention, it is possible to provide a sulfide solid battery system capable of improving the cycle characteristics.

A third aspect of the present invention is a sulfide solid battery system comprising: a solid battery including a cathode layer, an anode layer and a solid electrolyte layer disposed between the cathode layer and the anode layer; and a controller capable of controlling a charge-stopping voltage and a discharge-stopping voltage of the solid battery, wherein LiNiₓCo_{y}Mn_{z}O₂ is employed for the cathode layer and a sulfide solid electrolyte is employed at least for the solid electrolyte layer; and the discharge-stopping voltage is controlled by the controller in discharging the solid battery so that the discharging is stopped at 3.4 V or more with reference to a potential at which graphite stores/releases lithium ions and the charge-stopping voltage is controlled by the controller in charging the solid battery so that the charging is stopped at 4.4 V or less with reference to the potential at which graphite stores/releases lithium ions.

In the sulfide solid battery in which LiNiₓCo_{y}Mn_{z}O₂ is employed for the cathode active material, by setting the discharge-stopping voltage as 3.4 V or more, it is possible to obtain a good cycle characteristics even though the maximum voltage in charging is set as 4.4 V. Therefore, according to the third aspect of the present invention, it is possible to provide a sulfide solid battery system capable of improving the cycle characteristics.

A fourth aspect of the present invention is a method for controlling a sulfide solid battery including a cathode layer, an anode layer and a solid electrolyte layer disposed between the cathode layer and the anode layer, wherein LiNiₓCo_{y}Mn_{z}O₂ is employed for the cathode layer and a sulfide solid electrolyte is employed at least for the solid electrolyte layer, the method comprising: controlling a charge-stopping voltage of the solid battery in charging the solid battery so that the charging is stopped at 4.3V or less with reference to a potential at which graphite stores/releases lithium ions.

In the sulfide solid battery in which LiNiₓCo_{y}Mn_{z}O₂ is employed for the cathode active material, by setting the charge-stopping voltage as 4.3 V or less, it is possible to increase a capacity maintenance rate after 1000 cycles of repeated charging and discharging. Therefore, according to the fourth aspect of the present invention, it is possible to provide a method for controlling a sulfide solid battery capable of improving the cycle characteristics.

A fifth aspect of the present invention is a method for controlling a sulfide solid battery including a cathode layer, an anode layer and a solid electrolyte layer disposed between the cathode layer and the anode layer, wherein LiNiₓCo_{y}Mn_{z}O₂ is employed for the cathode layer and a sulfide solid electrolyte is employed at least for the solid electrolyte layer, the method comprising: controlling a discharge-stopping voltage in discharging the solid battery so that the discharging is stopped at 3.4 V or more with reference to a potential at which graphite stores/releases lithium ions.

In the sulfide solid battery in which LiNiₓCo_{y}Mn_{z}O₂ is employed for the cathode active material, by setting the discharge-stopping voltage as 3.4 V or more, it is possible to increase the capacity maintenance rate after 1000 cycles of repeated charging and discharging. Therefore, according to the fifth aspect of the present invention, it is possible to provide a method for controlling a sulfide solid battery capable of improving the cycle characteristics.

A sixth aspect of the present invention is a method for controlling a sulfide solid battery including a cathode layer, an anode layer and a solid electrolyte layer disposed between the cathode layer and the anode layer, wherein LiNiₓCo_{y}Mn_{z}O₂ is employed for the cathode layer and a sulfide solid electrolyte is employed at least for the solid electrolyte layer, the method comprising: controlling a discharge-stopping voltage of the solid battery in discharging the solid battery so that the discharging is stopped at 3.4 V or more with reference to a potential at which graphite stores/releases lithium ions and controlling a charge-stopping voltage of the solid battery in charging the solid battery so that the charging is stopped at 4.4 V or less with reference to the potential at which graphite stores/releases lithium ions.

In the sulfide solid battery in which LiNiₓCo_{y}Mn_{z}O₂ is employed for the cathode active material, by setting the discharge-stopping voltage as 3.4 V or more, it is possible to obtain a good cycle characteristics even though the maximum voltage in charging is set as 4.4 V. Therefore, according to the sixth aspect of the present invention, it is possible to provide a method for controlling a sulfide solid battery capable of improving the cycle characteristics.

In the present invention, the above-mentioned LiNiₓCo_{y}Mn_{z}O₂ may include a substance in which a small amount of element (for example, Al, Mg, W, Zr and the like) which is different from elements contained in the cathode is added. In a case where the cathode layer includes the cathode active material and the solid electrolyte, the “elements contained in the cathode” includes elements consisting of the cathode active material and elements consisting of the solid electrolyte.

### Effects of the Invention

According to the present invention, it is possible to provide a sulfide solid battery system and a method for controlling a sulfide solid battery which are capable of improving the cycle characteristics.

### BRIEF DESCRIPTION OF THE DRAWINGS

FIG. 1 is a view to explain a sulfide solid battery system 10;

FIG. 2 is a view to explain a sulfide solid battery system 20;

FIG. 3 is a view showing a relationship between the maximum voltage in charging and the capacity maintenance rate;

FIG. 4 is a view showing a relationship between the maximum voltage in charging and the internal resistance increase rate;

FIG. 5 is a view showing a relationship between the minimum voltage in discharging and the capacity maintenance rate;

FIG. 6 is a view showing a relationship between the minimum voltage in discharging and the internal resistance increase rate;

FIG. 7 is a view to explain a relationship between the maximum voltage in charging and the capacity maintenance rate;

FIG. 8 is a view to explain a relationship between the maximum voltage in charging and the internal resistance increase rate.

### DETAILED DESCRIPTION OF THE INVENTION

Hereinafter, the present invention will be described with reference to the drawings. Descriptions of a housing of the solid battery and the like are omitted in the drawings shown below. It should be noted that the embodiments shown below are examples of the present invention and that the present invention is not limited to these embodiments.

### 1. First Embodiment

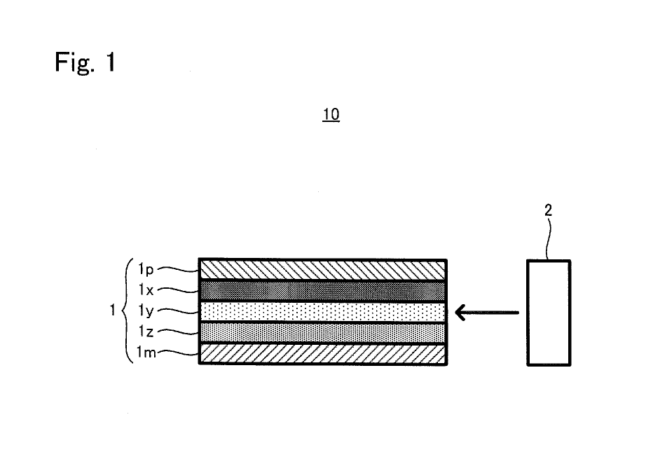

FIG. 1 is a view to explain a sulfide solid battery system 10 and a method for controlling a sulfide solid battery 1 of the present invention according to the first embodiment. The sulfide solid battery 1 and a controller 2 are shown simplified in FIG. 1. The sulfide solid battery system 10 shown in FIG. 1 includes the sulfide solid battery 1 and the controller 2 capable of controlling a charge-stopping voltage of the sulfide solid battery 1. The sulfide solid battery 1 includes a cathode layer 1x, an anode layer 1z, a solid electrolyte layer 1y disposed between the cathode layer 1x and the anode layer 1z, a cathode current collector 1p connected to the cathode layer 1x and an anode current collector 1m connected to the anode layer 1z. The cathode layer 1x contains at least a cathode active material and a solid electrolyte, LiNiₓCo_{y}Mn_{z}O₂ is employed for the cathode active material, and a sulfide solid electrolyte is employed for the solid electrolyte. The solid electrolyte layer 1y contains the sulfide solid electrolyte. The anode layer 1z contains an anode active material and a solid electrolyte, graphite is employed for the anode active material, and the sulfide solid electrolyte is employed for the solid electrolyte. In the sulfide solid battery system 10, the controller incorporates a control program capable of controlling charging of the sulfide solid battery 1 so that a charge-stopping voltage of the sulfide solid battery 1 becomes 4.3 V or less. In the sulfide solid battery system 10, for example, the controller 2 sends a signal to a charger that is not shown in FIG. 1 to stop the charging when the voltage of the sulfide solid battery 1 becomes 4.3 V, whereby the charge-stopping voltage is controlled to be 4.3 V or less.

The sulfide solid battery 1 in which LiNiₓCo_{y}Mn_{z}O₂ is employed for the cathode active material becomes possible to improve the cycle characteristics (to increase the capacity maintenance rate after repeated charging and discharging and to inhibit increase of the internal resistance increase rate after repeated charging and discharging. The same is applied hereinafter) by setting the charge-stopping voltage as 4.3 V or less. Therefore, according to the sulfide solid battery system 10, it is possible to improve the cycle characteristics. Moreover, by having a configuration in which the charge-stopping voltage of the sulfide solid battery 1 is controlled to be 4.3 V or less, it is possible to provide a method for controlling a sulfide solid battery capable of improving the cycle characteristics.

In the present invention, the cathode active material (LiNiₓCo_{y}Mn_{z}O₂) contained in the cathode layer 1x may be in a particle form or the like for example. The average particle diameter (D50) of the cathode active material is, for example, preferably 1 nm or more and 100 μm or less and more preferably 10 nm or more and 30 μm or less. The content of the cathode active material in the cathode layer 1x is not particularly limited and preferably 40% or more and 99% or less by mass % for example.

Moreover, as the sulfide solid electrolyte which can be employed for the cathode layer 1x, Li₂S—SiS₂, LiI—Li₂S—SiS₂, LiI—Li₂S—P₂S₅, LiI—Li₂S—P₂O₅, LiI—Li₂S—P₂S₅—LiO₂, LiI—Li₃PO₄—P₂S₅, Li₂S—P₂S₅ and the like can be exemplified.

Furthermore, in the present invention, it is preferable that the cathode active material is coated by an ion conductive oxide in view of having a configuration in which increase of battery resistance is easily prevented, by making it difficult to form a high resistance layer at the interface between the cathode active material and the sulfide solid electrolyte. As a lithium ion conductive oxide to coat the cathode active material, for example, an oxide represented by a general formula of LiₓAO_{y} (A is selected from the group consisting of B, C, Al, Si, P, S, Ti, Zr, Nb, Mo, Ta and W, and x and y each are positive numbers) can be given. In specific, Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, LiTaO₃, Li₂WO₄ and the like can be exemplified. Furthermore, the lithium ion conductive oxide may be a composite oxide. As the composite oxide to coat the cathode active material, any combination of the lithium ion conductive oxides described above can be employed. For example, Li₄SiO₄—Li₃BO₃, Li₄SiO₄—Li₃PO₄ and the like can be given. Furthermore, in a case where the ion conductive oxide coats a surface of the cathode active material, the ion conductive oxide is not particularly limited as long as the ion conductive oxide coats at least a part of the cathode active material, and the ion conductive oxide may coat a whole surface of the cathode active material. Furthermore, the thickness of the ion conductive oxide to coat the cathode active material is, for example, preferably 0.1 nm or more and 100 nm or less, and more preferably 1 nm or more and 20 nm or less. The thickness of the ion conductive oxide can be measured by means of a transmission electron microscope (TEM) and the like for example.

Moreover, the cathode layer 1x can be produced with a known binder and a known viscosity improver that can be contained in a cathode layer of a lithium-ion secondary battery. Acrylonitrile-butadiene rubber (ABR), butadiene rubber (BR), polyvinylidene fluoride (PVdF), styrene-butadiene rubber (SBR) and the like can be exemplified as the binder, and carboxymethylcellulose (CMC) and the like can be exemplified as the viscosity improver.

Further, the cathode layer 1x may contain a conductive material which improves conductivity. As the conductive material which can be contained in the cathode layer 1x, in addition to carbon materials such as vapor-grown carbon fibers, acetylene black (AB), ketjen black (KB), carbon nanotube (CNT) and carbon nanofibers (CNF), metal materials capable of enduring an environment of the sulfide solid battery 1 to use can be exemplified.

The cathode layer 1x can be produced by a known method. For example, in a case where the cathode layer 1x is produced with a cathode composition in slurry form adjusted by dispersing the cathode active material, the solid electrolyte and the binder described above and the like in a liquid, heptane and the like can be exemplified, and a nonpolar solvent can be preferably employed as the liquid. Furthermore, the thickness of the cathode layer 1x is, for example, preferably 0.1 μm or more and 1 mm or less, and more preferably 1 μm or more and 100 μm or less. Furthermore, in order to make it easy to increase a performance of the sulfide solid battery 1, it is preferable that the cathode layer 1x is produced through a process of pressing. In the present invention, the pressure in pressing the cathode layer 1x may be about 500 MPa.

Moreover, the solid electrolyte layer 1y may contain a known sulfide solid electrolyte. As the sulfide solid electrolyte, the above-mentioned sulfide solid electrolyte which can be contained in the cathode layer 1x and the like can be exemplified. Additionally, the solid electrolyte layer 1y can contain a binder to bind the solid electrolyte in view of developing flexibility and the like. As the binder, the binder that can be contained in the cathode layer 1x as described above can be given. The amount of the binder to be contained in the solid electrolyte layer 1y is preferably 5 mass % or less in view of making it possible to form the solid electrolyte layer 1y including the sulfide solid electrolyte not excessively aggregated but uniformly dispersed in order to easily obtain a high output.

The solid electrolyte layer 1y can be produced by a known method. For example, in a case where the solid electrolyte layer 1y is produced through the process of applying the solid electrolyte composition in slurry form in which the sulfide solid electrolyte described above and the like are dispersed and adjusted in a liquid, to the cathode layer 1x and the anode layer 1z and the like, heptane and the like can be exemplified, and a nonpolar solvent can be preferably used as the liquid to disperse the sulfide solid electrolyte and the like. The content of a solid electrolyte material in the solid electrolyte layer 1y is, for example, preferably 60% or more, more preferably 70% or more, especially preferably 80% or more by mass %. The thickness of the solid electrolyte layer 1y is, largely varying depending on configurations of battery, for example, preferably 0.1 μm or more and 1 mm or less, and more preferably 1 μm or more and 100 μm or less.

As the anode active material to be contained in the anode layer 1y, a known anode active material capable of storing/releasing lithium ions can be adequately employed. Graphite such as a highly oriented pyrolytic graphite (HOPG) can be exemplified as the anode active material, and together with the graphite, another carbon active material, an oxide active material and a metal active material and the like can be employed. Another carbon active material is not particularly limited as long as it contains carbon, and mesocarbon microbeads (MCMB), a hard carbon, a soft carbon and the like can be given for example. As the oxide active material, Nb₂O₅, Li₄Ti₅O₁₂, SiO and the like can be given for example. As the metal active material, In, Al, Si, Sn and the like can be given for example. A lithium-containing metal active material can also be employed as the anode active material. The lithium-containing metal active material is not particularly limited as long as it is an active material containing at least Li, and it can be a Li metal or a Li alloy. As the Li alloy, an alloy containing Li and at least one kind selected from the group consisting of In, Al, Si and Sn can be raised for example. The anode active material may be in a particle form, a thin film form and the like for example. The average particle diameter (D50) of the anode active material is, for example, preferably 1 nm or more and 100 μm or less, more preferably 10 nm or more and 30 μm or less. Moreover, the content of the anode active material in the anode layer 1z is not particularly limited, and preferably 40% or more and 99% or less by mass % for example.

Further, the anode layer 1z may contain a solid electrolyte, a binder binding the anode active material and the solid electrolyte, a conductive material which improves conductivity and a viscosity improver. As the solid electrolyte, binder, conductive material and viscosity improver that can be contained in the anode layer 1z, the above-mentioned solid electrolyte, binder, conductive material and viscosity improver that can be contained in the cathode layer 1x can be exemplified.

The anode layer 1z can be produced by a known method. For example, in a case where the anode layer 1z is produced with an anode composition in slurry form adjusted by dispersing the above-mentioned anode active material and the like in a liquid, heptane and the like can be exemplified, and a nonpolar solvent can be preferably employed as the liquid to disperse the anode active material and the like. Furthermore, the thickness of the anode layer 1z is, for example, preferably 0.1 μm or more and 1 mm or less, and more preferably 1 μm or more and 100 μm or less. In addition, in order to make it easy to increase the performance of the sulfide solid battery, it is preferable that the anode layer 1z is produced through a process of pressing. In the present invention, the pressure in pressing the anode layer 1z is preferably 400 MPa or more, and more preferably around 600 MPa.

Moreover, a known conductive material which can be used as a current collector of a solid battery can be employed for the cathode current collector 1p. A conductive material (including stainless steels (SUS)) including one or two or more element(s) selected from the group consisting of Ni, Cr, Au, Pt, Al, Fe, Ti, Zn and C can be exemplified as the conductive material.

Moreover, a known conductive material which can be used as a current collector of a solid battery can be employed for the anode current collector 1m. A conductive material (including stainless steels (SUS)) including one or two or more element(s) selected from the group consisting of Cu, Ni, Fe, Ti, Co, Zn and C can be exemplified as the conductive material.

The sulfide solid battery 1 can be used being accommodated in a known housing. A known laminate film and the like that can be used for a solid battery can be employed as the housing, and a laminate film made of resin, a film in which a metal is evaporated to a laminate film made of resin and the like can be exemplified as the laminate film.

Moreover, a known device which can be used when controlling a charge-stopping voltage of a battery can be adequately employed as the controller 2. In the sulfide solid battery system 10, the present invention has a unique configuration in which the sulfide solid battery 1 is controlled in charging so that the charge-stopping voltage of the sulfide solid battery becomes 4.3 V or less. A known device can be adequately employed as the device itself to be used in charging control described above.

### 2. Second Embodiment

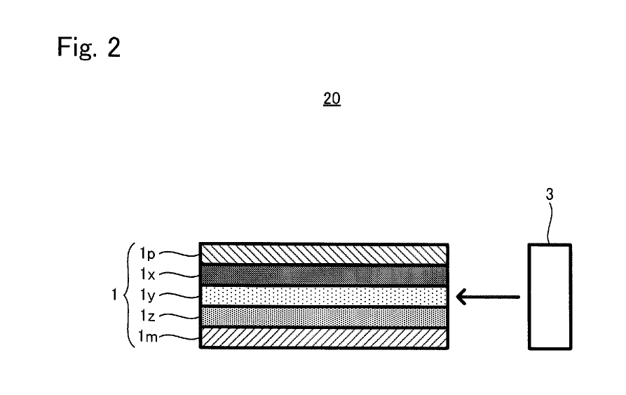

FIG. 2 is a view to explain a sulfide solid battery system 20 and a method for controlling the sulfide solid battery 1 of the present invention according to the second embodiment. The sulfide solid battery 1 and a controller 3 are shown simplified in FIG. 2. In FIG. 2, to the same structure as those in the sulfide solid battery system 10, the same reference numerals as those used in FIG. 1 are given and the explanation thereof is arbitrarily omitted.

The sulfide solid battery system 20 shown in FIG. 2 includes the sulfide solid battery 1, the controller 3 capable of controlling a charge-stopping voltage and a discharge-stopping voltage of the sulfide solid battery 1. In the sulfide solid battery system 20, the controller 3 incorporates a control program capable of controlling discharging of the sulfide solid battery 1 so that the discharge-stopping voltage of the sulfide solid battery 1 becomes 3.4 V or more and capable of controlling charging of the sulfide solid battery 1 so that the charge-stopping voltage of the sulfide solid battery 1 becomes 4.4 V or less. In the sulfide solid battery system 20, for example, to stop the discharging when the voltage of the sulfide solid battery 1 becomes 3.4 V, the connection between the sulfide solid battery 1 and a device which is not shown in FIG. 2 (the device which operates by means of power supply from the sulfide solid battery 1) is cut off as instructed from the controller 3, whereby the discharge-stopping voltage of the sulfide solid battery 1 is controlled to be 3.4 V or more. Further, in charging the sulfide solid battery 1, a signal is sent from the controller 3 to a charger which is not shown in FIG. 2 so that the charging is stopped when the voltage of the sulfide solid battery 1 becomes 4.4 V, and the charge-stopping voltage of the sulfide solid battery 1 is controlled to be 4.4 V or less.

When the discharge-stopping voltage is 3.4 V or more, it is possible for the sulfide solid battery 1 in which LiNiₓCo_{y}Mn_{z}O₂ is employed for the cathode active material to obtain a good cycle characteristics (to obtain a high capacity maintenance rate after repeated charging and discharging and to inhibit increase of the internal resistance increase rate after repeated charging and discharging) even though the sulfide solid battery 1 is charged to 4.4 V. Therefore, according to the sulfide solid battery system 20, it is possible to improve the cycle characteristics. Furthermore, by having a configuration in which the discharge-stopping voltage of the sulfide solid battery 1 is controlled to be 3.4 V and the charge-stopping voltage of the sulfide solid battery 1 is controlled to be 4.4 V or less, it is possible to provide a method for controlling a sulfide solid battery capable of improving the cycle characteristics.

In the above explanation of the present invention, the sulfide solid battery system 10 including the controller 2 capable of controlling the charging of the sulfide solid battery 1 so that the charge-stopping voltage becomes 4.3 V or less and the method for controlling it, and the sulfide solid battery system 20 including the controller 3 capable of controlling the charging and discharging of the sulfide solid battery 1 so that the discharge-stopping voltage becomes 3.4 V or more and the charge-stopping voltage becomes 4.4 V or less and the method for controlling it are described. However, the present invention is not limited to these embodiments. The present invention can be a sulfide solid battery system having a configuration in which a controller capable of controlling the discharging of the sulfide solid battery 1 so that the discharge-stopping voltage becomes 3.4 V or more is included instead of the controller 2 or the controller 3, and can be a method for controlling a sulfide solid battery, the method controlling the discharging of the sulfide solid battery 1 so that the discharge-stopping voltage becomes 3.4 V or more. Such a configuration can also improve the cycle characteristics of the sulfide solid battery 1.

### EXAMPLES

### 1. Production of Sulfide Solid Battery

[Production of Coated Cathode Active Material-1]

By means of a tumbling fluidized bed granulating-coating machine (manufactured by Pawrex Corporation), a cathode active material (LiNi_{1/3}CO_{1/3}Mn_{1/3}O₂) having an average particle diameter of 4 μm was coated by LiNbO₃ in an atmospheric environment, and by firing the resulting material in an atmospheric environment, a cathode active material coated by an ion conductive oxide (hereinafter, the cathode active material is sometimes referred to as “first cathode active material”) was produced.

[Production of Coated Cathode Active Material-2]

A cathode active material coated by an ion conductive oxide was produced in the same manner as in the above description except that coating of LiNbO₃ and firing were carried out under a dry environment in which the dew point is −30° C. or less (hereinafter, this cathode active material is sometimes referred to as “second cathode active material”).

[Production of Cathode Layer]

A heptane solution containing a solution of a butadiene rubber-based binder in an amount of 5 mass %, the cathode active material (the first cathode active material or the second cathode active material), a sulfide solid electrolyte (Li₂S—P₂S₅ based glass ceramics including LiI) having an average particle diameter of 2.5 μm and a conductive assistant (vapor-grown carbon fiber) were put in a polypropylene container. The contents were stirred for 30 seconds by means of an ultrasonic dispersion apparatus (UH-50, manufactured by SMT Co., Ltd. The same is applied hereinafter) thereafter shaken for 3 minutes by means of a shaker (TTM-1, manufactured by Shibata Scientific Technology Ltd., the same is applied hereinafter) followed by further stirring for 30 seconds by means of the ultrasonic dispersion apparatus. The resulting composition made by means of stirring-shaking-stirring as described was applied on a cathode collector (an Al foil to which carbon is applied (SDX, manufactured by Showa Denko K.K., “SDX” is a registered trademark of Showa Denko Packaging Co., Ltd., the same is applied hereinafter)) by a blade method by means of an applicator. Thereafter, the resulting cathode collector on which the composition was applied was dried for 30 minutes on a hot plate having a temperature of 100° C., whereby a cathode layer was produced.

[Production of Anode Layer]

A heptane solution containing a solution of a butadiene rubber-based binder in an amount of 5 mass %, an anode active material (a natural graphite based carbon having an average particle diameter of 10 μm (manufactured by Mitsubishi Chemical Corporation)) and a sulfide solid electrolyte (Li₂S—P₂S₅ based glass ceramics including LiI) having an average particle diameter of 2.5 μm were put in a polypropylene container. The contents were stirred for 30 seconds by means of the ultrasonic dispersion apparatus, thereafter shaken by the shaker for 30 minutes. The resulting composition made by means of stirring and shaking as described was applied on an anode current collector (Cu foil) by a blade method by means of an applicator. After that the anode current collector on which the composition is applied was dried for 30 minutes on a hot plate having a temperature of 100° C., whereby an anode layer was produced.

[Production of Solid Electrolyte Layer]

A heptane solution containing a solution of a butadiene rubber-based binder in an amount of 5 mass % and a sulfide solid electrolyte (Li₂S—P₂S₅ based glass ceramics including LiI) having an average particle diameter of 2.5 μm were put in a polypropylene container. The contents were stirred for 30 seconds by means of the ultrasonic dispersion apparatus, thereafter shaken by a shaker for 30 minutes. The resulting composition made by means of stirring and shaking as described was applied on an Al foil by a blade method by means of an applicator. After that, the Al foil on which the composition is applied was dried for 30 minutes on a hot plate having a temperature of 100° C., and the dried material on the Al foil was removed from the Al foil, whereby a solid electrolyte layer was obtained.

[Production of Sulfide Solid Battery]

The solid electrolyte layer produced by the above method was put in a mold having a size of 1 cm² and pressed at 1 tf/cm² (≈98 MPa). Thereafter, the cathode layer formed on a surface of the cathode current collector was disposed on one side of the pressed solid electrolyte layer so that the cathode layer containing the first cathode active material or the cathode layer containing the second cathode active material and the solid electrolyte layer have contact with each other, and pressed at 1 tf/cm² (≈98 MPa). After that, the anode layer formed on a surface of the anode current collector was disposed on the other side (the side where the cathode layer is not disposed) so that the anode layer and the solid electrolyte layer have contact with each other, and pressed at 4 tf/cm² (≈392 MPa) whereby a sulfide solid battery was produced.

### 2. Charge/Discharge Cycle Characteristics Test

### Example 1

The sulfide solid battery produced with the cathode layer containing the first cathode active material was used.

The following steps of (1) to (4) were repeated for 1000 cycles under an environment of 60° C.

(1) Charging the battery to 4.1 V with a constant current at 0.5 hour rate (2C rate); thereafter,
(2) leaving the battery for 10 minutes; thereafter,
(3) discharging the battery to 2.5 V with a constant current at 0.5 hour rate (2C rate); thereafter,
(4) leaving the battery for 10 minutes.
Capacity confirmation and resistance measurement each described later were carried out for several times before finishing the 1000 cycles.

The sulfide solid battery after repeated 1000 cycles was charged at a constant current and constant voltage to 4.55 V at 3 hour rate (⅓C rate). Thereafter, the battery was left for 10 minutes. After that, discharging capacity when discharging at a constant current to 3.0 V at 3 hour rate (⅓C rate) was obtained. Then, comparing the discharging capacity after 1 cycle obtained in the same manner, the rate (=the discharging capacity after 1000 cycles/the discharging capacity after 1 cycle×100) was defined as a capacity maintenance rate [%].

Moreover, the sulfide solid battery after 1000 cycles was charged at a constant current and constant voltage to 3.6 V corresponding to stop current 1/100C rate thereafter left for 10 minutes. After that, the battery was discharged at a constant current for 5 seconds at 0.33 hour rate (3C rate) and the internal resistance (R=ΔV/ΔI) of the battery was obtained from voltage drop and the current value at that time. Thereafter, comparing with the internal resistance of the battery after 1 cycle obtained in the same manner, the rate (=the internal resistance after 1000 cycles/the internal resistance after 1 cycle×100) was defined as an internal resistance increase rate [%].

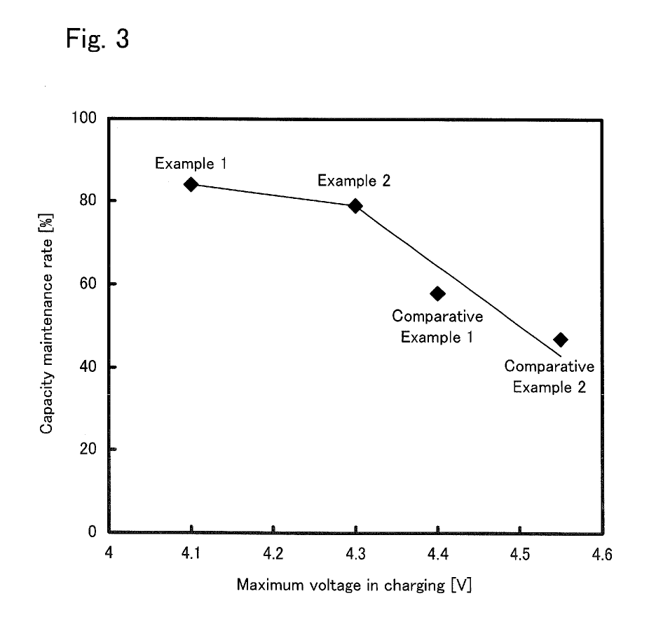

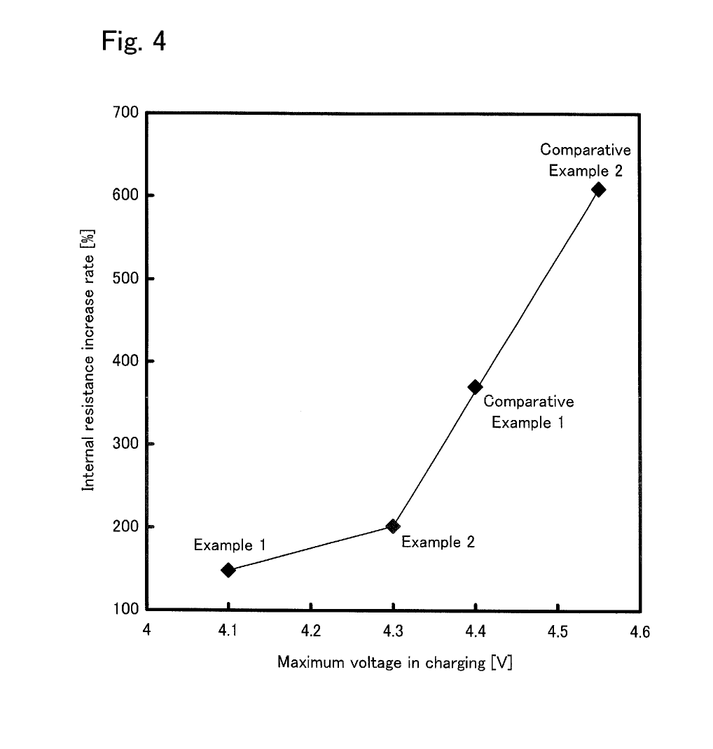

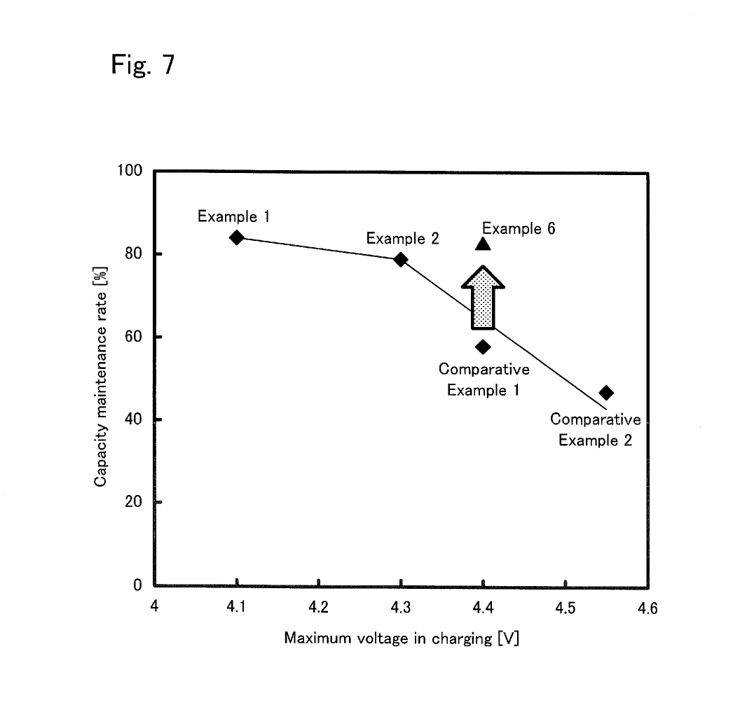

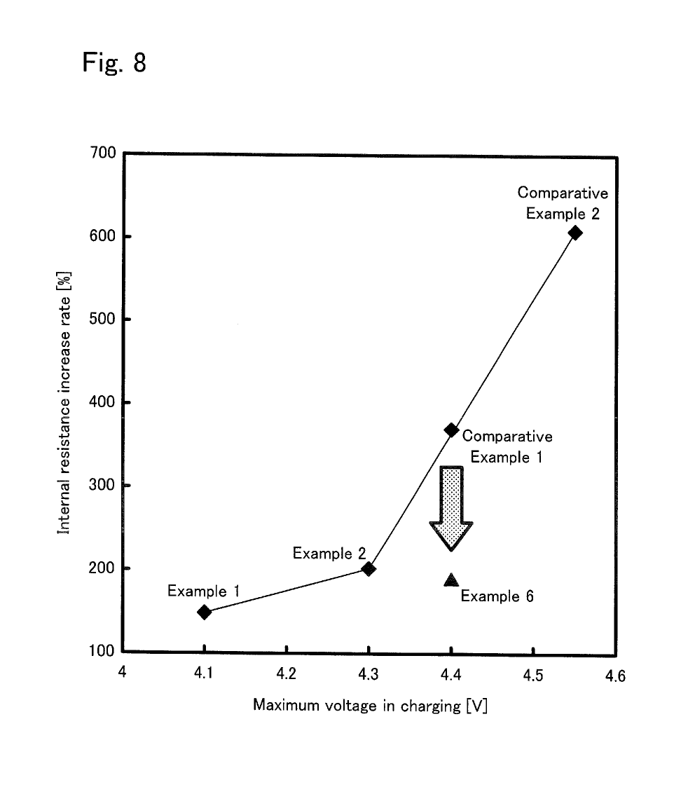

Conditions of charge/discharge cycle, the results of the capacity maintenance rate and the results of the internal resistance increase rate of the Example 1 are shown in Table 1 and FIGS. 3, 4, 7 and 8. The capacity maintenance rate [%] is taken along the vertical axis of FIGS. 3 and 7, and the maximum voltage in charging [V] is taken along the horizontal axis. The internal resistance increase rate [%] is taken along the vertical axis of FIGS. 4 and 8, and the maximum voltage in charging [V] is taken along the horizontal axis. The results positioned the upper side of plane of paper of FIGS. 3 and 7 have the better performance, and the results positioned the lower side of plane of paper of FIGS. 4 and 8 have the better performance.

### Example 2

In the same conditions as in Example 1 except that the sulfide solid battery produced with the cathode layer containing the first cathode active material was used and the charge-stopping voltage is 4.3 V, 1000 cycles of charging and discharging were carried out. Then the capacity maintenance rate and the internal resistance increase rate were obtained in the same manner as in Example 1. Conditions of charge/discharge cycle, the results of the capacity maintenance rate and the results of internal resistance increase rate of Example 2 are shown in Table 1 and FIGS. 3, 4, 7 and 8.

### Example 3

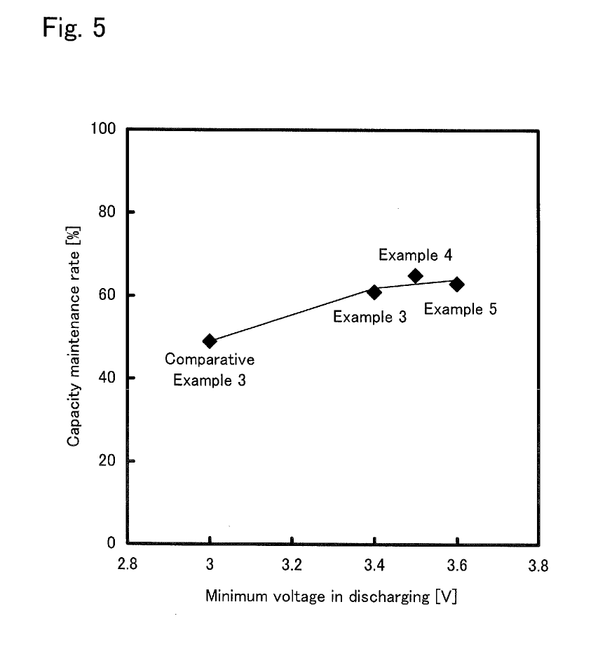

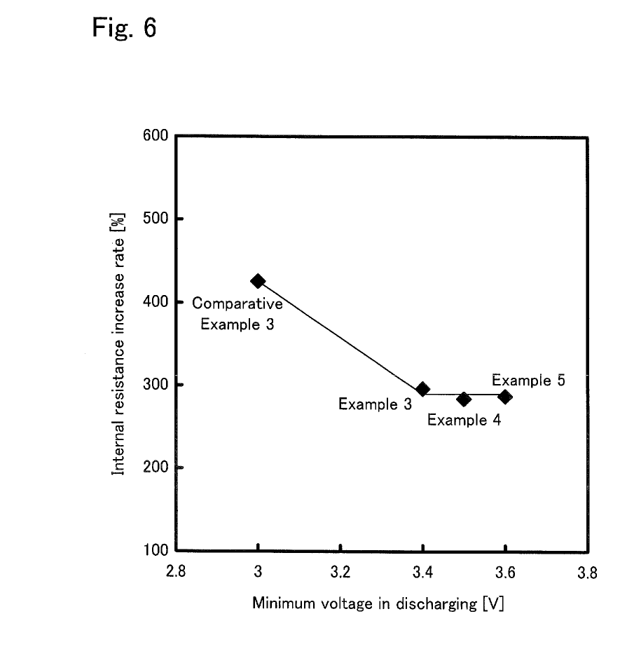

In the same conditions as in Example 1 except that the sulfide solid battery produced with the cathode layer containing the second cathode active material was used, the charge-stopping voltage was 4.4 V and the discharge-stopping voltage was 3.4 V, 1000 cycles of charging and discharging were carried out. Then the capacity maintenance rate and the internal resistance increase rate were obtained in the same manner as in Example 1. Conditions of charge/discharge cycle, the results of the capacity maintenance rate and the results of internal resistance increase rate of Example 3 are shown in Table 1 and FIGS. 5 and 6. The capacity maintenance rate [%] is taken along the vertical axis of FIG. 5 and the minimum voltage in discharging [V] is taken along the horizontal axis. The internal resistance increase rate [%] is taken along the vertical axis of FIG. 6 and the minimum voltage in discharging [V] is taken along the horizontal axis. The results positioned the upper side of plane of paper of FIG. 5 have the better performance, and the results positioned the lower side of plane of paper of FIG. 6 have the better performance.

### Example 4

In the same conditions as in Example 1 except that the sulfide solid battery produced with the cathode layer containing the second cathode active material was used, the charge-stopping voltage was 4.4 V and the discharge-stopping voltage was 3.5 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of internal resistance increase rate of Example 4 are shown in Table 1 and FIGS. 5 and 6.

### Example 5

In the same conditions as in the Example 1 except that the sulfide solid battery produced with the cathode layer containing the second cathode active material was used, the charge-stopping voltage was 4.4 V and the discharge-stopping voltage was 3.6 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of the internal resistance increase rate of Example 5 are shown in Table 1 and FIGS. 5 and 6.

### Example 6

In the same conditions as in Example 1 except that the sulfide solid battery produced with the cathode layer containing the first cathode active material was used, the charge-stopping voltage was 4.4 V and the discharge-stopping voltage was 3.4 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of internal resistance increase of Example 6 are shown in Table 1 and FIGS. 7 and 8.

### Comparative Example 1

In the same conditions as in Example 1 except that the sulfide solid battery produced with the cathode layer containing the first cathode active material was used and the charge-stopping voltage was 4.4 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of internal resistance increase rate of Comparative Example 1 are shown in Table 1 and FIGS. 3, 4, 7 and 8.

### Comparative Example 2

In the same conditions as in Example 1 except that the sulfide solid battery produced with the cathode layer containing the first cathode active material was used and the charge-stopping voltage was 4.55 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of internal resistance increase rate of Comparative Example 2 are shown in table 1 and FIGS. 3, 4, 7 and 8.

### Comparative Example 3

In the same conditions as in Example 1 except that the sulfide solid battery produced with the cathode layer containing the second cathode active material was used, the charge-stopping voltage was 4.4 V and the discharge-stopping voltage was 3.0 V, 1000 cycles of charging and discharging were carried out. Then the capacity maintenance rate and the internal resistance increase rate were obtained in the same manner as in Example 1. Conditions of charge/discharge cycle, the results of capacity maintenance rate and the results of internal resistance increase rate of the Comparative Example 3 are shown in Table 1 and FIGS. 5 and 6.

TABLE 1

| | | | Atmosphere in | | |
|---|---|---|---|---|---|
| | | | coating/firing of | Capacity | Internal |
| | Maximum voltage | Minimum voltage | cathode active | maintenance rate | resistance |
| | in charging [V] | in discharging [V] | material | [%] | increase rate [%] |
| Example 1 | 4.1 | 2.5 | atmpspheric | 84 | 148 |
| Example 2 | 4.3 | 2.5 | atmpspheric | 79 | 202 |
| Example 3 | 4.4 | 3.4 | dry | 61 | 296 |
| Example 4 | 4.4 | 3.5 | dry | 65 | 284 |
| Example 5 | 4.4 | 3.6 | dry | 63 | 287 |
| Example 6 | 4.4 | 3.4 | atmpspheric | 83 | 190 |
| Comparative | 4.4 | 2.5 | atmpspheric | 58 | 370 |
| Example 1 | | | | | |
| Comparative | 4.55 | 2.5 | atmpspheric | 47 | 609 |
| Example 2 | | | | | |
| Comparative | 4.4 | 3.0 | dry | 49 | 426 |
| Example 3 | | | | | |

### 3. Results

As shown in Table 1 and FIGS. 3 and 4, from the results of Example 1, Example 2, Comparative Example 1 and Comparative Example 2, the capacity maintenance rate was increased and the internal resistance increase rate was decreased by setting the maximum voltage in charging of the sulfide solid battery as 4.3 V or less. That is, by setting the maximum voltage in charging of the sulfide solid battery as 4.3 V or less, it was possible to increase the performance maintenance rate after charging and discharging cycles. It can be considered that the performance maintenance rate was increased since the change amount of expansion and contraction of the cathode active material was small and it was easy to maintain the contact of the cathode active material with the sulfide solid electrolyte in the conditions of Example 1 and Example 2. In a solid battery, if the active material and the electrolyte become difficult to contact with each other due to expansion and contraction, the battery performance becomes decreased, which is different from a case of a battery prepared with an electrolytic solution (liquid battery). In the liquid battery, since the electrolytic solution permeates between the active material, performance degradation due to expansion and contraction of the active material is smaller than that of the solid battery.

Moreover, as shown in Table 1 and FIGS. 5 and 6, from the results of Example 3, Example 4, Example 5 and Comparative Example 3, the capacity maintenance rate was increased and the internal resistance increase rate was decreased by setting the minimum voltage in discharging the sulfide solid battery as 3.4 V or more. That is, by setting the minimum voltage in discharging of the sulfide solid battery as 3.4 V or more, it was possible to increase the performance maintenance rate after charge/discharge cycles. It can be considered that, when the minimum volume in discharging was less than 3.4 V, the performance maintenance rate was decreased since the change amount of expansion and contraction of the cathode active material became large and it became difficult to maintain the contact of the cathode active material with the sulfide solid electrolyte. Comparing the sulfide solid battery prepared with the first cathode active material and the sulfide solid battery prepared with the second cathode active material, the former showed a better property.

Moreover, as shown in Table 1 and FIGS. 7 and 8, especially from the results of Example 6 in which the maximum voltage in charging was 4.4 V and the minimum voltage in discharging was 3.4 V and Comparative Example 1 in which the maximum voltage in charging was 4.4 V and the minimum voltage in discharging was 2.5 V, it was confirmed that it is possible to increase the performance maintenance rate after charge/discharge cycles by setting the minimum voltage in discharging of the sulfide solid battery as 3.4 V or more, even though the battery is charged to 4.4 V. It can be considered that, since the amount of expansion and contraction of the cathode active material becomes small by setting the discharge-stopping voltage as 3.4 V, whereby it becomes possible to inhibit deterioration of battery due to the expansion and contraction in charging as the amount of expansion and contraction becomes small, it is possible to increase the performance maintenance rate after charge/discharge cycles by setting the minimum voltage in discharging of the sulfide solid battery as 3.4 V or more even though the battery is charged to 4.4 V.

### DESCRIPTION OF THE REFERENCE NUMERALS

1 sulfide solid battery
1m anode current collector
1p cathode current collector
1x cathode layer
1y solid electrolyte layer
1z anode layer
2, 3 controller
10, 20 sulfide solid battery system

1. A sulfide solid battery system comprising: a solid battery including a cathode layer, an anode layer and a solid electrolyte layer disposed between the cathode layer and the anode layer; and a controller capable of controlling a charge-stopping voltage of the solid battery,
wherein
LiNiₓCo_{y}Mn_{z}O₂ (x+y+z=1 and 0.32<x, y, z<0.34) is employed for the cathode layer and a sulfide solid electrolyte is employed at least for the solid electrolyte layer, and
the charge-stopping voltage of the solid battery is controlled by the controller in charging the solid battery so that the charging is stopped at 4.3 V or less with reference to a potential at which graphite stores/releases lithium ions.

2. A sulfide solid battery system comprising: a solid battery including a cathode layer, an anode layer and a solid electrolyte layer disposed between the cathode layer and the anode layer; and a controller capable of controlling a discharge-stopping voltage of the solid battery,
wherein
LiNiₓCo_{y}Mn_{z}O₂ (x+y+z=1 and 0.32<x, y, z<0.34) is employed for the cathode layer and a sulfide solid electrolyte is employed at least for the solid electrolyte layer, and
the discharge-stopping voltage of the solid battery is controlled by the controller in discharging the solid battery so that the discharging is stopped at 3.4 V or more with reference to a potential at which graphite stores/releases lithium ions.

3. The sulfide solid battery system according to claim 2,
wherein
the controller is also capable of controlling a charging-stopping voltage of the solid battery
and the charge-stopping voltage of the solid battery is controlled by the controller in charging the solid battery so that the charging is stopped at 4.4 V or less with reference to the potential at which graphite stores/releases lithium ions.

4-6. (canceled)
